(19) United States
(12) Patent Application Publication
(10) Pub. No.: US 2004/0248994 A1
(43) Pub. Date: Dec. 9, 2004

(54) Corrosion inhibitors for lacquered and unlacquered tin plated aerosol canisters

(76) Inventors: Mattia De Dominicis, Mira (IT); Zefferino Righetto, Mira (IT)

Correspondence Address: NORRIS, MCLAUGHLIN & MARCUS, 875 THIRD AVE, 18TH FLOOR, NEW YORK, NY, 10022, US

(21) Appl. No.: 10/490,721

(22) PCT Filed: Sep. 20, 2002
(86) PCT No.: PCT/GB02/04277

(30) Foreign Application Priority Data
Sep. 26, 2001 (GB) 0123060.6

(51) Int. Cl. C09K 3/30

(52) U.S. Cl. 516/6; 516/8

(57) ABSTRACT

The invention relates to a system comprising a silicate and a base which is a gas at room temperature, for inhibiting corrosion from aqueous based formulations within aerosol containers. In particular for tin-plated aerosol canisters and in particular aerosol canisters containing aqueous alkaline aerosol formulations.

The invention relates to a system comprising a silicate and a base, which is volatile at room temperature, for inhibiting corrosion from aqueous based formulations within aerosol containers. In particular for tin-plated aerosol canisters and in particular aerosol canisters containing aqueous alkaline aerosol formulations.

### BACKGROUND OF THE INVENTION

Many products designed for household, hard surfaces, fabric care, carpet cleaners are sold in aerosol containers. A few aerosol products are sold in glass or plastic containers. Most containers are metal canisters, most canisters are steel, usually tin coated, others are aluminium (which are the most expensive). Tin coated metal canisters may also be lacquered with a resin on the inside to provide additional protection.

Examples of aerosol products are air fresheners, car products, household products, fabric care, waxes, polishes, insecticides, ironing aids, fabric refreshers, and carpet cleaners.

Tin coating protects the metal canisters against rapid corrosion, but tends itself to dissolve in aqueous based formulations. With aerosol formulations containing less than 50 ppm of water, corrosion of tin plated canisters is not generally a serious problem. However, if the water content of an aerosol product is more than 50 ppm (ideally greater than 150 ppm), problems due to corrosion are more likely to occur.

The world market trend is to move towards water based aerosol formulations. This is due mainly to a regulatory issue; the reductions of the volatile organic content (VOC) levels in aerosol product has involved the reduction of the solvent level in many products and an increase of the water content.

Many corrosion inhibitor systems have been developed for the new market requirements in aerosol products, especially for tin plated canisters. Examples of these products are borates, benzoates, molybdate, and surfactants (such as sodium lauroyl sarcosinate). The best recognised inhibitor system for tin plated canisters is sodium nitrite and morpholine. Morpholine is a volatile base that helps to preserve the vapour phase in the aerosol containers and gives an alkaline pH to the formula. This system can involve the formation of nitrosamines that are very carcinogenic. In addition, even sodium nitrite and morpholine are not generally able to prevent the dissolution of the tin coating, but to reduce the rate of dissolution of the tin coating to an acceptable level. The amount of morpholine, sodium nitrite and thickness of tin plate are designed for around the required shelf life, for example two years. The dissolution of the tin plate to form a tin hydroxyl-oxide complex has been shown to have a negative effect on cleaning performances. The tin complex generally gives a pale yellow to an intense yellow colour when deposited, especially when sprayed onto a white surface. White fabrics or carpets can remain coloured by the liquids of aged aerosol products. Other considerations relate to certain stains like coffee, tea and wine that contain cationic metals. These metals can form brown coloured complex with tin hydroxyl-oxide complex, causing an evident negative effect of the cleaning formulation and its overall cleaning performance.

Even resin lacquered tin-plated canisters generally need an effective corrosion system. Possible defects on the lacquer layer are the cause of pit corrosion: where a galvanic potential is discharged in a limited area, involving a quick and deep corrosion. Even sodium nitrite and morpholine, cannot prevent dissolution of the lacquer and tin plate, the liquid becomes yellowish and the interior can darken. This system is in addition to be avoided for nitrosamine formation during the product life.

### SUMMARY OF THE INVENTION

Many corrosion inhibitors have been identified in the prior art, but are not able to stop the dissolution of the tin layer in a tin plated aerosol canister over the two year standard canister life.

It has been surprisingly found that silicates are very effective corrosion inhibitors for tin plated or lacquered tin plated aerosol canisters if they are combined with a base which is volatile at room temperature they form a complete corrosion inhibitor systems, which is also able to preserve the canister in the vapour and liquid phase. What has been found is that the system preserves the tin layer, leaving it with a mirror appearance even after six months of storage stability at 40° C. This unexpected discovery avoids almost all the negative defects of the existing corrosion inhibitors:

No toxicological impact. Silicates are effective as corrosion inhibitors at low concentration and they don't have any impact on the final formulation toxicological profile, neither are they involved in the formation of carcinogenic compounds.

They avoid the yellowing of the formulation caused by the dissolution of the tin layers and the associated negative effects.

The interior canister appearance remains preserved.

Pit corrosion is minimised even in the case of a non-homogeneously applied resin protective layer.

The formation of solid particles from tin dissolution is avoided. Tin dissolution can generate tin hydroxyl/oxide non-soluble complexes. These complexes tend to form solid particles that can block the valve/actuator during spraying.

Other advantages of silicates are that they are very effective even at low concentration, starting from 0.01% wt of the contents of the canister.

Other relevant characteristic is their low cost and low impact on the overall formula cost.

By the use of the term “room temperature” we mean at <30° C., <25° C., <20° C. or <15° C.

Suitable volatile bases that are gases at room temperature are selected from primary, secondary, tertiary and quartenary amines; preferred amines are primary and quartenary amines, especially ammonia.

### DETAILED DESCRIPTION

Broadly a large number of silicates can be used “characterised by the presence of the elements silicon, oxygen, and one or more metals with or without hydrogen”— quoted from The Condensed Chemical Dictionary, 6^{th} Edition, Reinhold Publishers.

A preferred silicate is defined by either of the following formulae:

xSiO₂:yM₂O, where M is Na, K or Li and x:y is the molar ratio between SiO₂ and M₂O and is a ratio of from 0.1:1 to 10:1, preferably from 1.6:1 to 4:1; or

xSiO₂:yM₂O:zAl₂O₃, where M is defined above and x:y:z is the molar ratio between SiO₂, M₂O and Al₂O₃, and each x,y or z is independently a number in the range 0.1 to 10.

The level of silicate is in the range 0.0001-10% wt of the total contents of the canister, preferably in the range 0.001-5% wt, and more preferably between 0.01-0.5% wt.

The silicates are optionally used in combination with other liquid phase corrosion inhibitors, such as benzoate, phosphate, nitrite and borate, preferably in the form of a sodium salt. An example of a specific borate is Monacor BE supplied by Uniqema which is a mono ethanol/mono isopropyl amine borate.

The silicates are preferably used in an alkaline formulation with a pH between 7-14, preferably between 8-11 (when measured as a neat in the active formulation).

Suitable volatile bases that are gases at room temperature are selected from primary, secondary, tertiary and quartenary amines; preferred amines are primary and quartenary amines, especially ammonia.

Preferred volatile bases that are gases at room temperature are selected from ammonia, morpholine and R3N, where in each R is independently selected from hydrogen, C₁-₁₂ alkyl or a C₁₋₁₂ alcohol. A suitable volatile base that is a gas at room temperature can be provided by adding a compound containing, for example, an amine species such as MEA/MIPA borate (trade name is Monacor BE supplied by Uniqema), where MEA stands for Mono ethanolamine and MIPA stands for Mono isopropylamine. The base which is a gas at room temperature is added in the range of 0.001-5% wt of the total contents of the canister, preferably between 0.005-0.5% wt.

The propellant is a pressurised gas, including carbon dioxide, air, nitrogen, nitrous oxide, as well as hydrocarbon gases [for example, propane, butane, pentane, isobutane, isopentane or a mixture thereof—(such as, for example, A-46 and A-70 available from Phillips Petroleum, CAP 40 and CAP 48 available from Shell, BPAP 40 available from BP Chemicals)], dimethyl ether, hydrofluorocarbons and mixtures of any thereof. Preferred gases are butane/propane mixtures. The propellant level is in the range 1-50% wt of the total contents of the canister, preferably between 4-15% wt.

The level of the liquid phase (the liquid phase consisting of the active formulation and the aspects of the corrosion system which are not in the gaseous phase at room temperature) is between 1-99% wt, preferably between 75-96% wt of the total contents of the canister.

Ideally the active formulation comprises (all values being expressed in terms of the content of the formulation).

at least one surfactant, either anionic, non-ionic or cationic in the range 0.01 to 50% w/v, ideally from 0.1 to 10% w/v and preferably from 0.5 to 5% w/v;

a super wetting agent used between 0.01 to 10% w/v, preferably from 0.1 to 5% w/v;

at least one builder, either a polymer or a chelating agent in the range 0.01-40% w/v and preferably from 0.1-10% w/v;

an organic solvent at levels of 0.01 to 40% w/v, more preferably between 0.5 to 15% w/v;

optional minor ingredients such as antifoaming agents, fragrances, hydrotropes, preservatives, dyes or a mixture of any thereof. Minor ingredients are present in an amount of up to 3% w/w of the liquid phase.

Examples of surfactants considered in this invention are either anionic surfactant, non-ionic surfactant, cationic and super wetting agents. Preferred total levels of surfactant are from 0.01 to 50% w/v, ideally from 0.1 to 10% w/v and preferably 0.5 to 5% w/v of the formulation.

Example of non-ionic surfactant is described in the formula RO(CH2CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohols containing about twelve to about 16 carbon atoms which are condensed with about three to thirteen moles of ethylene oxide.

Other examples of non-ionic surfactants include primary alcohol ethoxylates (available under the Neodol tradename from Shell Co.), such as C11 alkanol condensed with 9 moles of ethylene oxide (Neodol 1-9), C12-13 alkanol condensed with 6.5 moles ethylene oxide (Neodol 23-6.5), C12-13 alkanol with 9 moles of ethylene oxide (Neodol 23-9), C12-15 alkanol condensed with 7 or 3 moles ethylene oxide (Neodol 25-7 or Neodol 25-3), C14-15 alkanol condensed with 13 moles ethylene oxide (Neodol 45-13), C9-11 linear ethoxylated alcohol, averaging 2.5 moles of ethylene oxide per mole of alcohol (Neodol 91-2.5), and the like.

Other examples of non-ionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C11-15 secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type non-ionic surfactants, for example, Triton X-100, as well as amine oxides can also be used as a non-ionic surfactant in the present invention.

Other examples of linear primary alcohol ethoxylates are available under the Tomadol tradename such as, for example, Tomadol 1-7, a C11 linear primary alcohol ethoxylate with 7 moles EO; Tomadol 25-7, a C12-C15 linear primary alcohol ethoxylate with 7 moles EO; Tomadol 45-7, a C14-C15 linear primary alcohol ethoxylate with 7 moles EO; and Tomadol 91-6, a C₉-C₁₁ linear alcohol ethoxylate with 6 moles EO.

Amine oxides can also be used as the non-ionic surfactant of the present invention. Exemplary useful amine oxide compounds may be defined as one or more of the following of the four general classes:

(1) Alkyl di (lower alkyl) amine oxides in which the alkyl group has about 6-24, and preferably 8-18 carbon atoms, and can be straight or branched chain, saturated or unsaturated. The lower alkyl groups include between 1 and 7 carbon atoms, but preferably each include 1-3 carbon atoms. Examples include octyl dimethyl amine oxide, lauryl dimethyl amine oxide, myristyl dimethyl amine oxide, and those in which the alkyl group is a mixture of different amine oxides, such as dimethyl cocoamine oxide, dimethyl (hydrogenated tallow) amine oxide, and myristyl/palmityl dimethyl amine oxide;

(2) Alkyl di (hydroxy lower alkyl) amine oxides in which the alkyl group has about 6-22, and preferably 8-18 carbon atoms, and can be straight or branched chain, saturated or unsaturated. Examples include bis-(2-hydroxyethyl) cocoamine oxide, bis(2-hydroxyethyl) tallowamine oxide; and bis-(2-hydroxyethyl) stearylamine oxide;

(3) Alkylamidopropyl di(lower alkyl) amine oxides in which the alkyl group has about 10-20, and preferably 12-16 carbon atoms, and can be straight or branched chain, saturated or unsaturated. Examples include cocoamidopropyl dimethyl amine oxide and tallowamidopropyl dimethyl amine oxide; and

(4) Alkylmorpholine oxides in which the alkyl group has about 10-20, and preferably 12-16 carbon atoms, and can be straight or branched chain, saturated or unsaturated.

Useful anionic surfactant are frequently provided in a salt form, such as alkali metal salts, ammonium salts, amine salts, amino alcohol salts or magnesium salts. Contemplated as useful are one or more sulfate or sulfonate compounds including: alkyl sulfates, alkyl ether sulfates, alkylamidoether sulfates, alkyl benzene sulfates, alkyl benzene sulfonates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl carboxylates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other examples of anionic surfactants are also alkyl naphthalene sulfonate anionic surfactants of the formula:

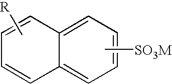

wherein R is a straight chain or branched alkyl chain having from about 1 to about 25 carbon atoms, saturated or unsaturated, and the longest linear portion of the alkyl chain is 15 carbon atoms or less on the average, M is a cation which makes the compound water soluble especially an alkali metal such as sodium or magnesium, ammonium or substituted ammonium cation.

Other examples are alkyl sarcosinate, sulfosuccinate and alkyl sulfate anionic surfactants of the formula

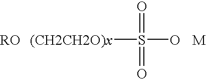

wherein R is a straight chain or branched alkyl chain having from about 8 to about 18 carbon atoms, saturated or unsaturated, and the longest linear portion of the alkyl chain is 15 carbon atoms or less on the average, M is a cation which makes the compound water soluble especially an alkali metal such as sodium or magnesium, ammonium or substituted ammonium cation, and x is from 0 to about 4. Most preferred are the non-ethoxylated C12-15 primary and secondary alkyl sulfates, especially sodium lauryl sulfate.

Most desirably, the anionic surfactant according to constituent is selected to be of a type that dries to a friable powder. This facilitates their removal from carpets and carpet fibres, such as by brushing or vacuuming.

The cationic surfactants of the invention are quaternary ammonium salts which may be characterised by the general structural formula:

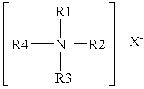

wherein R1, R2, R3 and R4 are independently selected from alkyl, aryl or alkylaryl substituent of from 1 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl and arylalkyl. The remaining substituents on the nitrogen atoms other than the above mentioned alkyl substituents are hydrocarbons usually containing no more than 12 carbon atoms. The substituents R1, R2, R3 and R4 may be straight-chained or may be branched, but are preferably straight-chained, and may include one or more amide, ether or ester linkages.

The counterion X- are selected from halogens anions, saccharinate, alkyl and alkyl benzene sulfate, sulfonate and fatty acid.

The level of cationic compound used is 0.01% to 10% w/v, a preferred range is 0.1 to 1% w/v of the formulation.

Super wetting agents are used between 0.01 to 10% w/v, preferably from 0.1 to 5% w/v of the formulation. The super wetting agents of this invention are silicone glycol copolymers and fluorosurfactants.

The silicone glycol copolymers are described by the following formula:

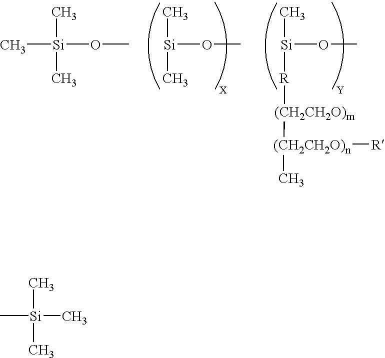

Where x, y, m and n are whole number ranging from 0 to 25. X is preferred between 0-10 and y, m and n between 0-5. R and R′ are straight chain or branched alkyl chain having from about 1 to about 25 carbon atoms, saturated or unsaturated, and the longest linear portion of the alkyl chain is 15 carbon atoms or less on the average. The fluorinated surfactant is described in the following formulae:

F(CF₂)ₙ—CH₂CH₂—S—CH₂CH₂—COOM

F(CF₂)ₙ—N(CH3)(CH2)₃—(CH₂CH₂O)ₓOSO₂M

CF₃(CF₂CF₂)ₙ(CFCF)ₘ—(CH₂CH₂O)ₓ—OPO₃M₂

Wherein n, m and x are integers having a value from 0 to 15; preferred values are between 1 and 12. M is a cation which makes the compound water-soluble especially an alkali metal such as sodium or magnesium, ammonium or substituted ammonium cation.

The super wetting agents described are able to lower the surface tension (when 1 g is dissolved in 1 c of water) in water at values below 25 mN/m, in the range between 18 and 25 mN/m at concentrations of 0.0001 to 1% w/v, preferably between 0.001 to 0.1% w/v of the formulation.

Organic solvents should be water-miscible or water emulsionable. The organic solvent is found at levels of 0.01 to 40% w/v, more preferably between 0.5 to 15% w/v of the formulation. The organic solvent constituent of the inventive compositions include one or more alcohols, glycols, acetates, ether acetates, glycol ethers and hydrocarbons. Exemplary alcohols useful in the compositions of the invention include C2-C8 primary and secondary alcohols which may be straight chained or branched. Exemplary alcohols include pentanol and hexanol. Exemplary glycol ethers include those glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to glycol monomer units. Preferred are glycol ethers having 1 to 5 glycol monomer units.

By way of further non-limiting example specific organic constituents include propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate and particularly useful is, propylene glycol phenyl ether, ethylene glycol hexyl ether, diethylene glycol hexyl ether. Examples of hydrocarbons solvents are linear and branched, saturated and unsaturated carbon chain with a number of carbon atoms from C4-C40, preferably from C6-C22.

The chelating agent is added at a level between 0.01 to 10% w/v, preferably between 0.1 to 2% w/v of the formulation. Examples of chelating agents are described below:

the parent acids of the monomeric or oligomeric polycarboxylate chelating agents or mixtures therefore with their salts, e.g. citric acid or citrate/citric acid mixtures are also contemplated as useful builder components.

borate builders, as well as builders containing borate-forming materials than can produce borate under detergent storage or wash conditions can also be.

iminosuccinic acid metal salts

polyaspartic acid metal salts.

examples of bicarbonate and carbonate builders are the alkaline earth and the alkali metal carbonates, including sodium carbonate and sesqui-carbonate and mixtures thereof. Other examples of carbonate type builders are the metal carboxy glycine and metal glycine carbonate.

ethylene diamino tetra acetic acid and salt forms.

water-soluble phosphonate and phosphate builders are useful for this invention.

Examples of phosphate builders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders are the alkali metal tripolyphosphates, sodium potassium and ammonium pyrophosphate, sodium and potassium and ammonium pyrophosphate, sodium and potassium orthophosphate, sodium polymeta/phosphate in which the degree of polymerisation ranges from 6 to 21, and salts of phytic acid.

The polymers used in this invention at a level between 0.01 to 30% w/v, preferably between 0.1 to 5% w/v of the formulation. Examples of polymers are: water-soluble compounds include the water soluble monomeric polycarboxylates, or their acid forms, homo or copolymeric polycarboxylic acids or their salts in which the polycarboxylic acid comprises at least two caroxylic radicals separated from each other by not more than two carbon atoms, carbonates, bicarbonates, borates, phosphates, and mixtures of any of thereof. The carboxylate or polycarboxylate builder can be monomeric or oligomeric in type although monomeric polycarboxylates are generally preferred for reasons of cost and performance. Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447. Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates contining sulfo substituents include the sulfosuccinate derivatives disclosed in GB-A-1,398,421, GB-A-1,398,422 and U.S. Pat. No. 3,936,448, and the sulfonated pyrolsed citrates described in GB-A-1,439,000. Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates. More preferred polymers are homo-polymers, copolymers and multiple polymers of acrylic, fluorinated acrylic, sulfonated styrene, maleic anhydride, metacrylic, iso-butylene, styrene and ester monomers.

Examples of these polymers are Acusol supplied from Rohm & Haas, Syntran supplied from Interpolymer and Versa and Alcosperse series supplied from Alco Chemical, a National Starch & Chemical Company.

The performance of the new corrosion inhibitor system has been compared systems available on the market. To evaluate the performances a real condition canister storage test was carried out. A quick method that avoids the need to gas the canister has been identified for preliminary corrosion behaviour evaluation, the jar method.

Jar Method

50 ML glass jars with screw plugs are used in this test.

A round piece of canister is cut and applied on the internal surface of the jar screw plug. A poly tetra fluoroethylene gasket is also applied on the plug in order to guarantee a good sealing system. The jar is filled with the testing formula and it is stored in the inverted position for obtaining the contact between the liquid formula and the tin plated canister piece applied on the plug. The stress test is carried out in an oven at 50° C. for several days up to 1 month and a cross is cut by a blade on the canister piece in order to simulate possible defects on the canister walls.

The storage situation is monitored after 1 day, 1 week, 2 weeks, and 1 month and compared to reference canister pieces and liquids. The canister piece and liquid appearances are recorded. A recording data table with the corresponding corrosion rating is reported below:

| Corrosion | Canister piece | |
|---|---|---|
| Rating JM | appearance | Liquid appearance |
| 0 | No difference from | No difference from |
| | reference | reference |
| 1 | Low darkening along the | No difference from |
| | cut lines | reference |
| 2 | Darkening along the | No difference from |
| | cut lines | reference |
| 3 | Low darkening on all the | No difference from |
| | canister piece area | reference |
| 4 | Darkening on all the | No difference from |
| | canister piece area | reference |
| 5 | Darkening on all the | Pale yellowish of the |
| | canister piece area | liquid |
| 6 | Evident darkening on all | Yellowish of the liquid |
| | the canister piece area | |
| 7 | Rust points | Rust |

The higher the rating number then the worse the corrosion inhibitor system efficiency.

Storage Test:

The storage test was carried out using final product conditions. Unlacquered and lacquered tin-plated canisters were filled with the formula under evaluation and gassed with the propellant.

The samples under evaluation were stored at 5, 20 and 40° C. for up to 6 months or at least at 40° C., considered as the condition at which corrosion reactions are quicker. The canisters were placed in an upright or inverted position to evaluate the efficacy of the silicates versus the entire canister and valve components during the storage test.

At scheduled storage time, two canisters in the inverted and two in the upright position are de-gassed, opened and the liquid phase and interior can appearance evaluated. The storage test corrosion rating is described in the table below:

| Corrosion | | |
|---|---|---|
| Rating ST | Canister/valve appearance | Liquid appearance |
| A | No difference from reference | No difference from reference |
| B | Low darkening | No difference from reference |
| C | Darkening | No difference from reference |
| D | Darkening | Pale yellowish of the liquid |
| E | Evident darkening | Pale yellowish of the liquid |
| F | Evident darkening | Yellowish of the liquid |
| G | Evident darkening | Yellowish of the liquid with |
| | | solid residue |
| H | Rust points | Rust |
| I | Rust points with canister | Rust |
| | leakage | |

### EXAMPLES

The liquid phases are typically prepared by mixing all the components together in a suitable container to form a concentrate, placing an amount of the concentrate in a suitable container useful to dispense aerosols, and then the propellant is added. Examples of compositions forming a part of the present invention are set forth below in Table 1, 2 and 3 with the various components identified in Table 4.

TABLE 1

| | Ref 1 | Ref 2 | Ref 3 | Ref 4 | Ref 5 | Ex 1 |
|---|---|---|---|---|---|---|
| Components | % | % | % | % | % | % |
| Monawet | 2.860 | 2.860 | 2.860 | 2.860 | 2.860 | 2.860 |
| SNO-35 | | | | | | |
| Zonyl 7950 | 0.700 | 0.700 | 0.700 | 0.700 | 0.700 | 0.700 |
| Zelan 338 | 0.150 | 0.150 | 0.150 | 0.150 | 0.150 | 0.150 |
| Hexyl | 0.750 | | | | | |
| cellosolve | | | | | | |
| Dowanol PnP | | 0.750 | 0.750 | 0.750 | 0.750 | 0.750 |
| Sodium citrate | 0.114 | 0.114 | 0.114 | 0.114 | 0.114 | |
| Citric acid | | | | | | 0.114 |
| Preservative | 0.100 | 0.100 | 0.100 | 0.100 | 0.100 | 0.100 |
| Fragrance | 0.134 | 0.134 | 0.134 | 0.134 | 0.134 | 0.134 |
| Sodium nitrite | 0.100 | | | | | |
| Crystal 0075 | | | | | | 0.200 |
| Sodium | | | 0.300 | 0.300 | | |
| benzoate | | | | | | |
| Sodium | | | | | 0.100 | |
| molybdate | | | | | | |
| Monacor BE | | | | 0.300 | | |
| Ammonium | 0.007 | 0.007 | 0.007 | 0.007 | 0.007 | 0.007 |
| hydroxide 30% | | | | | | |
| DI water | 95.085 | 95.085 | 94.88 | 94.585 | 95.085 | 94.915 |

The liquid formulations reported on table 1 were gassed with butane propellant with a ratio concentrate/propellant=93/7 wt/wt, double lacquered canisters were used.

TABLE 2

| | Ref 6 | Ref 7 | Ref 8 | Ref 9 | Ex 2 | Ex 3 |
|---|---|---|---|---|---|---|
| Components | % | % | % | % | % | % |
| Texapon | 7.514 | 7.514 | 7.514 | 7.514 | 7.514 | 7.514 |
| 101 AR | | | | | | |
| Crodasinic | 2.496 | 2.496 | 2.496 | 2.496 | 2.496 | 2.496 |
| LS30 | | | | | | |
| Incromine | 2.898 | 2.989 | 2.989 | 2.989 | 2.989 | 2.989 |
| oxide S | | | | | | |
| Sodium nitrite | 0.100 | | | | | |
| Dowanol PnP | | | | | | |
| Citric Acid | | | | | 0.0087 | |
| Crystal 0075 | | | | | 0.05 | 0.05 |
| Sodium | | | 0.075 | 0.075 | | 0.0375 |
| benzoate | | | | | | |
| Monacor BE | | | 0.075 | | | 0.0375 |
| Morpholine | 0.100 | 0.100 | | | | |
| Ammonium | | | 0.0125 | 0.025 | 0.025 | 0.0062 |
| hydroxide 30% | | | | | | |
| DI water | 86.801 | 86.901 | 86.8385 | 86.901 | 86.9173 | 86.8698 |

The liquid formulations reported on table 2 were gassed with butane propellant with a ratio concentrate-propellant=94/6 wt/wt, unlacquered canisters were used.

TABLE 3

| | Ref 10 | Ex 4 | Ref 11 | Ref 12 | Ex 5 |
|---|---|---|---|---|---|
| Components | % | % | % | % | % |
| Dowanol PnP | | | 17.00 | 17.00 | 17.00 |
| Dowanol DPnB | 4.50 | 4.50 | | | |
| Dowanol DPM | 12.50 | 12.50 | | | |
| Genapol 26-L-60 | | | 0.20 | 0.20 | 0.20 |
| Genapol 26L-80 | 0.20 | 0.20 | | | |
| Crystal 0075 | | 0.20 | | | 0.20 |
| Sodium benzoate | 0.60 | 0.30 | 0.30 | 0.30 | 0.30 |
| Monacor BE | 0.80 | 0.50 | | 0.80 | 0.50 |
| Eltesol SC40 | 2.50 | 2.50 | | | |
| Ammonium | 0.05 | 0.05 | 0.05 | 0.05 | 0.05 |
| DI water | 78.85 | 79.25 | 82.45 | 81.65 | 81.75 |

The liquid formulations reported on Table 3 were gassed with butane propellant with a ratio concentrate/propellant=94/6 wt/wt, unlacquered canisters were used.

TABLE 4

| | Ref 13 | Ex 6 | Ex 7 |
|---|---|---|---|
| Components | % | % | % |
| Crodasinic LS30 | 3.192 | 3.192 | 3.192 |
| Empicol LX28/Z | 9.536 | 9.536 | 9.536 |
| Milloxid S | 3.830 | 3.830 | 3.830 |
| Neocryl A 550 | 2.553 | 2.553 | 2.553 |
| Disodium phosphate | 0.531 | 0.531 | 0.531 |
| Sodium Benzoate | 0.531 | 0.300 | 0.300 |
| Crystall 0075 | | 0.200 | 0.200 |
| Monacor BE | | 0.497 | |
| Morpholine | 0.099 | | |
| Ammonium hydroxide 30% | | 0.100 | 0.200 |
| DI water | 79.728 | 79.261 | 79.894 |

The liquid formulations reported on Table 4 were gassed with butane propellant with a ratio concentrate/propellant=94/6 wt/wt, unlacquered canisters were used.

TABLE 5

| Component | Description of component |
|---|---|
| Monawet SNO-35 | Na4DicarboxyethylStearySulfosuccinate from |
| | Uniqema |
| Zonyl 7950 | Fluorosurfactant from Dupont |
| Zelan 338 | Acrylic polymer from Dupont |
| Hexyl cellosolve | Ethylene Glycol Monohexyl Ether |
| Dowanol PnP | 2-Propoxy propanol from Dow Chemical |
| Sodium citrate | Na citrate |
| Citrate acid | Citric acid |
| Preservative | Preservatives from various supplier |
| Fragrance | Fragrances from variou supplier |
| Sodium nitrite | Sodium nitrite |
| Crystal 0075 | Silicate from Ineos Silicas |
| Sodium benzoate | Sodium benzoate |
| Disodium | Disodium phosphate |
| phosphate | |
| Sodium molybdate | Sodium molybdate |
| Dowanol DPM | Depropylene glycol methyl ether from Dow |
| | Chemical |
| Genapol 26-L-60 | Primary alcohol ethoxylate from Hoechst |
| | Celanese |
| Genapol 326-L-80 | Primary alcohol ethoxylate from Hoechst |
| | Celanese |
| Eltesol SC40 | Sodium cumene sulponate 40% from Albright & |
| | Wilson |
| Texapon 101 AR | Sodium lauryl sulfate from Henkel |
| Crodasinic LS30 | Sodium lauroyl sarcosinate from Croda |
| Empicol LX28/Z | Sodium lauryl sulfate from Hutsman |
| Milloxid S | Stearyl dimethyl amine oxide from Millchem |
| Neocryl A 550 | Acrylic copolymer from Zeneca |
| Morpholine | Morpholine |
| Ammonium | Ammonium hydroxide |
| hydroxide 33% | |
| DI water | Deionized water |

### EXAMPLE RESULTS

The silicate corrosion inhibitor system has been tested for all formulations previously described in terms of the Jar method and real condition storage stability.

Results for Table 1 Formulations:

Corrosion rating
(Jar method)

| Product | 1 day | 1 week | 2 weeks | 1 month |
|---|---|---|---|---|
| Ref 1 | 1 | 2 | 2 | 2-3 |
| Ref 2 | 1 | 2 | 2 | 3 |
| Ref 3 | 0 | 1 | 1 | 2 |
| Ref 4 | 0 | 1 | 1 | 1-2 |
| Ref 5 | 1 | 1 | 2 | 3 |
| Ex 1 | 0 | 0 | 0 | 0 |

| | Corrosion rating | | | |
|---|---|---|---|---|
| | (Storage test) | | | |
| | 1 month | | 2 months | |
| Product | T = 20° C. | T = 40° C. | T = 20° C. | T = 40° C. |
| Ref 1 | A | C | D | F |
| Ref 2 | A | C | C | D |
| Ref 3 | A | C | C | F |
| Ref 4 | B | C | F | H |
| Ref 5 | A | D | F | H |
| Ex 1 | A | A | B | C |

Results for Table 2 Formulations

Corrosion rating
(Jar method)

| Product | 1 day | 1 week | 2 weeks | 1 month |
|---|---|---|---|---|
| Ref 6 | 4 | 6 | 6 | 6 |
| Ref 2 | 3 | 6 | 6 | 6 |
| Ref 7 | 3-4 | 5 | 6 | 6 |
| Ref 8 | 3 | 4-5 | 6 | 6 |
| Ref 9 | 3 | 4-5 | 6 | 6 |
| Ex 2 | 0 | 0 | 0 | 0 |
| Ex 3 | 0 | 0 | 0 | 0 |

| | Corrosion rating | | | |
|---|---|---|---|---|
| | (Storage test) | | | |
| | 1 month | | 2 months | |
| Product | T = 20° C. | T = 40° C. | T = 20° C. | T = 40° C. |
| Ref 6 | C | H | F | H |
| Ref 7 | D | D | F | F |
| Ref 8 | C-D | D | F | F |
| Ref 9 | C-D | H | F | H |
| Ex 2 | A-B | A-B | C | C |
| Ex 3 | A-B | A-B | C | D |

Results for Table 3 Formulations:

| | Corrosion rating | | | | | |
|---|---|---|---|---|---|---|
| | (Storage test) | | | | | |
| | 6 weeks | | 3 months | | 6 months | |
| Product | T = 20° C. | T = 40° C. | T = 20° C. | T = 40° C. | T = 20° C. | T = 40° C. |
| Ref 10 | C | D | D | G | E | H |
| Ex 4 | A | A-B | A | A-B | A | A-B |
| Ref 11 | C-D | D-E | D | D-E | E | F |
| Ref 12 | D | D-E | D | D-E | E | E-F |
| Ex 5 | A | A-B | A | A-B | A | A-B |

Results for Table 4 Formulations:

| | Corrosion rating | | | |
|---|---|---|---|---|
| | (Storage test) | | | |
| | 6 weeks | | 3 months | |
| Product | T = 20° C. | T = 40° C. | T = 20° C. | T = 40° C. |
| Ref 13 | D | E | E | F |
| Ex 6 | A | B | A | B |
| Ex 6 | A | B | A | B |

1. An aerosol product comprising:
a) a tin plated, optionally lacquered canister;
b) a propellant;
c) an active formulation having an alkaline pH of between 8 and 11; and
d) a canister corrosion inhibitor characterised in that the canister corrosion inhibitor comprises a silicate and a base which is volatile at room temperature.

2. An aerosol product as claimed in claim 1 wherein the silicate contains the elements silicon, oxygen and one or more metals with or without hydrogen.

3. An aerosol product as claimed in claim 3 wherein the silicate is defined as
xSiO₂:yM₂O, where M is Na, K or Li and x:y is the molar ratio between SiO₂ and M₂O and is a ratio of from 0.1:1 to 10:1, preferably from 1.6:1 to 4:1; or
xSiO₂:yM₂O:zAl₂O₃, where M is defined above and x:y:z is the molar ratio between SiO₂, M₂O and Al₂O₃, and each x,y or z is independently a number in the range 0.1 to 10.

4. An aerosol product according to claim 1 comprising at least one other corrosion inhibitor selected from borate, phosphate, benzoate and nitrite, preferably present as a sodium salt, is also present.

5. An aerosol product according to claim 1 comprising wherein the base which is volatile at room temperature is an amine.

6. An aerosol product according to as claimed in claim 5 wherein the amine is ammonia.

7. An aerosol product according to claim 1 comprising an active formulation and/or propellant which has more than 50 ppm of water.

8. An aerosol product according to claim 1 wherein as claimed in any preceding claim wherein, the propellant is a pressurised gas, selected from carbon dioxide, air, nitrogen, nitrous oxide, hydrocarbon gas (for example, propane, butane, pentane, isobutane, isopentane and mixtures thereof), dimethyl ether, hydrofluorocarbons and mixtures of any thereof.

9. An aerosol product according to as claimed in claim 8 wherein the pressurised gas is a butane/propane mixture.

10. An aerosol product according to claim 8 as claimed in either claim 8 or claim 9 wherein, the level of propellant is in the range 1-50% wt of the total contents of the canister.

11. An aerosol product according to claim 1 as claimed in any preceding claim in which the level of silicate is 0.0001-10% wt of the total contents of the canister.

12. An aerosol product as claimed in claim 11 wherein the level of silicate is in the range 0.001-5% wt of the total contents of the canister.

13. An aerosol product as claimed in any preceding claim in which the level of the base which is volatile at room temperature is 0.001-5% wt of the total contents of the canister.

14. An aerosol product according to claim 1 wherein, the active formulation comprises:
at least one surfactant, in the range 0.01 to 50% w/v;
a super wetting agent in the range of 0.01 to 10% w/v;
at least one of a builder, polymer or a chelating agent in the range 0.01-40%;
an organic solvent in the range of of 0.01 to 40% w/v;
and, optionally one or more minor ingredients such as antifoaming agents, fragrances, hydrotropes, preservatives, dyes or a mixture of any thereof.

15. A method of preventing corrosion of a tin plated, and optionally lacquered, aerosol canister which method comprises adding a silicate and a base which is volatile at room temperature to the propellant and/or active formulation within the canister.
